(19) United States
(12) Patent Application Publication
(10) Pub. No.: US 2018/0066681 A1
(43) Pub. Date: Mar. 8, 2018

(54) HYDRAULIC STABILIZING SYSTEM

(71) Applicant: LIPPERT COMPONENTS, INC., Elkhart, IN (US)

(72) Inventor: Nicholas Cornett, Granger, IN (US)

(21) Appl. No.: 15/693,756

(22) Filed: Sep. 1, 2017

Related U.S. Application Data
(60) Provisional application No. 62/384,824, filed on Sep. 8, 2016.

(51) Int. Cl. F15B 13/042; F15B 11/04; F15B 13/02; F15B 1/26

(52) U.S. Cl. CPC F15B 13/042; F15B 11/04; F15B 13/027; F15B 1/26; F15B 13/024

(57) ABSTRACT

A hydraulic stabilizing system includes a pump having first and second flow ports, and first and second actuators, each having an extend chamber and a retract chamber. A first pilot-operated check valve is installed between the pump first flow port and the extend chamber of the first actuator. A second pilot-operated check valve is installed between the pump first flow port and the extend chamber of the second actuator. A third pilot-operated check valve is installed between the pump second flow port and the retract chambers of the first and second actuators. The pilot ports of the first and second pilot-operated check valves are coupled to the second pump flow port, and the pilot port of the third pilot-operated check valve is coupled to the first pump flow port.

### CROSS-REFERENCE TO RELATED APPLICATION

The application claims benefit under 35 U.S.C. § 119 of U.S. Provisional Patent Application No. 62/384,824, filed on Sep. 8, 2016, and incorporates by reference the disclosure thereof in its entirety. Any discrepancy between the disclosure of the foregoing application and the disclosure of this application shall be resolved in favor of the disclosure of this application.

### BACKGROUND AND SUMMARY OF THE DISCLOSURE

Hydraulic leveling systems for recreational vehicles are known in the art. Such systems typically include a plurality of hydraulic actuators, a fluid pump, a motor for driving the fluid pump, a fluid reservoir, hydraulic lines connecting the foregoing components, and a plurality of valves controlling the flow of fluid to and from the foregoing components through the hydraulic lines. Such systems also may include electrical actuators for controlling the position of the foregoing valves.

### BRIEF DESCRIPTION OF THE DRAWINGS

FIG. 1 is a schematic diagram of a hydraulic circuit for a first illustrative embodiment of a hydraulic stabilizing system according to the present disclosure;

FIG. 2 is a schematic diagram of a hydraulic circuit for a second illustrative embodiment of a hydraulic stabilizing system according to the present disclosure;

FIG. 3 is a schematic diagram of a hydraulic circuit for a third illustrative embodiment of a hydraulic stabilizing system according to the present disclosure;

FIG. 4 is a schematic diagram of a hydraulic circuit for a fourth illustrative embodiment of a hydraulic stabilizing system according to the present disclosure;

FIG. 5 is a schematic diagram of a hydraulic circuit for a fifth illustrative embodiment of a hydraulic stabilizing system according to the present disclosure;

FIG. 6 is a schematic diagram of a hydraulic circuit for a sixth illustrative embodiment of a hydraulic stabilizing system according to the present disclosure; and

FIG. 7 is a schematic diagram of a hydraulic circuit for a seventh illustrative embodiment of a hydraulic stabilizing system according to the present disclosure.

### DETAILED DESCRIPTION OF THE DRAWINGS

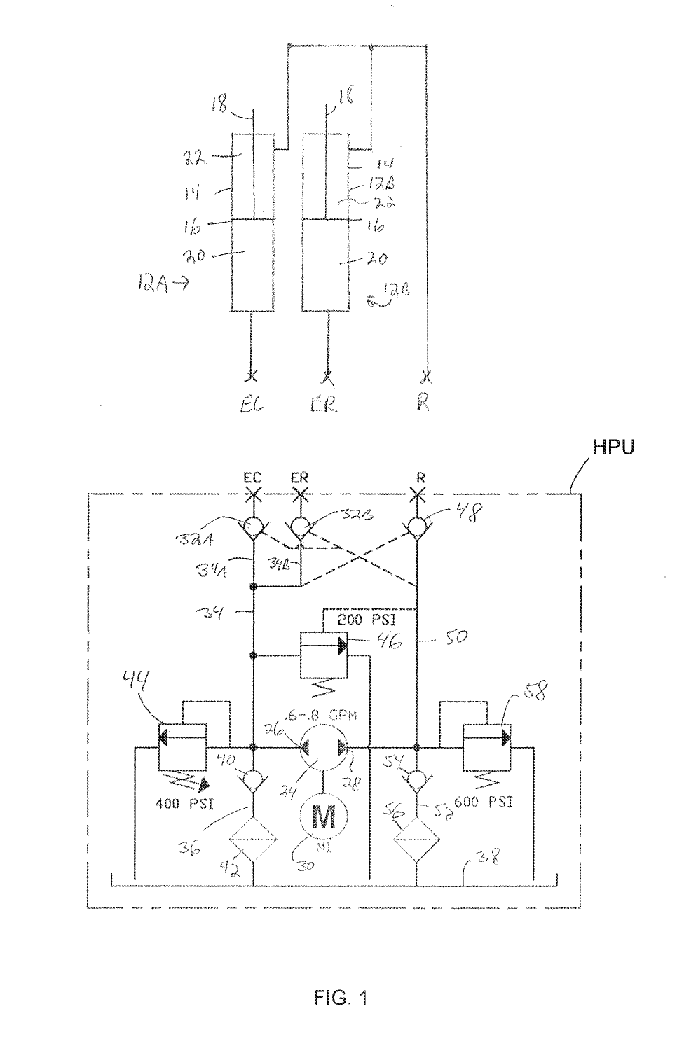

FIGS. 1-5 are schematic diagrams of hydraulic circuits for several illustrative embodiments of a hydraulic stabilizing system 10 according to the present disclosure. Each of the embodiments includes a plurality of hydraulic actuators 12A-12n. Each of the actuators 12A-12n includes a cylinder 14, a piston 16 reciprocable within the cylinder, and a piston rod 18 extending from the piston. A foot (not shown) may be rigidly or pivotally attached to the free end of the piston rod 18 opposite its connection to the piston 16. The cylinder 14 and the piston 16 cooperate to define a first (or extend) chamber 20. The hydraulic cylinder 14 and piston 16 also cooperate to define a second (or retract) chamber 22.

Each of the actuators 12A-12n may be mounted to a chassis of a vehicle (not shown), for example, a trailer or recreational vehicle. The piston rod 18 of each cylinder 14 may be selectively extended from the cylinder so as to position the foot or the free end of the piston rod against the ground upon which the vehicle may be parked to stabilize the vehicle with respect to the ground.

Each of the embodiments also includes a hydraulic power unit (HPU) configured to operate the actuators 12A-12n.

FIG. 1 is a schematic diagram of a hydraulic circuit for a first illustrative embodiment of a hydraulic stabilizing system 10 according to the present disclosure. The system 10 includes a first hydraulic actuator 12A and a second hydraulic actuator 12B. The first actuator 12A may be mounted to a curb (or passenger) side of a vehicle near the front or rear of the vehicle, and the second actuator 12B may be mounted to a road (or driver) side of the vehicle near the front or rear of the vehicle.

The system 10 also includes an HPU including a bi-directional hydraulic pump 24 for selectively providing pressurized hydraulic fluid to the extend and retract chambers 20, 22 of the first and second actuators 12A, 12B. The pump 24 has a first pump (flow) port 26 and a second pump (flow) port 28. A bi-directional motor 30 is operably connected to the pump 24 and configured to selectively drive the pump in a first (or extend) direction and a second (or retract) direction.

The first pump port 26 is hydraulically coupled to a first flow port of a first pilot-operated check valve 32A via a first extend line 34A. (Hydraulic connections to flow ports are shown in the drawings as solid lines, and hydraulic connections to pilot ports are shown in the drawings as dashed lines.) A second flow port of the first pilot-operated check valve 32A is hydraulically coupled to the extend chamber 20 of the first cylinder 12A by a hydraulic line EC (extend curbside). The first pilot-operated check valve 32A is normally closed to check (or block) flow from the second flow port thereof to the first flow port thereof. The first pilot-operated check valve 32A normally enables forward flow, that is, flow from the first flow port thereof to the second flow port thereof, in response to fluid pressure at the first flow port thereof being greater than fluid pressure at the second flow port thereof. The first pilot-operated check valve 32A enables reverse flow, that is, flow from the second flow port thereof to the first flow port thereof, when fluid pressure at a pilot port thereof exceeds a corresponding predetermined pressure (sometimes referred to herein as the first pilot-operated check valve set point), thereby opening the valve.

The first pump port 26 also is hydraulically coupled to a first flow port of a second pilot-operated check valve 32B via a second extend line 34B. As shown, a portion of the second extend line 34B may be common with the first extend line 34A, the common portion being designated in the drawings as extend line 34. A second flow port of the second pilot-operated check valve 34B is hydraulically coupled to the extend chamber 20 of the second cylinder 12B by a hydraulic line ER (extend roadside). The second pilot-operated check valve 32B is normally closed to check flow from the second flow port thereof to the first flow port thereof. The second pilot-operated check valve 32B enables forward flow, that is, flow from the first flow port thereof to the second flow port thereof, in response to fluid pressure at the first flow port thereof being greater than fluid pressure at the second flow port thereof. The second pilot-operated check valve 32B enables reverse flow, that is, flow from the second flow port thereof to the first flow port thereof, when fluid pressure at a pilot port thereof exceeds a corresponding predetermined pressure (sometimes referred to herein as the second pilot-operated check valve set point), thereby opening the valve.

The first pump port 26 also is hydraulically coupled to a first suction line 36 having a free end configured to draw fluid from a hydraulic fluid reservoir 38. A first suction line check valve 40 and a first suction line filter/strainer 42 are disposed in the first suction line 36 between the reservoir 38 and the first pump port 26, with the first suction line filter/strainer on the reservoir side of the first suction line check valve.

The first pump port 26 further is hydraulically coupled to a first flow port and a pilot port of a first pressure relief valve 44 and to a first flow port of a second pressure relief valve 46. A pilot port of the second pressure relief valve 46 is hydraulically coupled to a retract line 50, as will be discussed further below. Each of the first pressure relief valve 44 and the second pressure relief valve 46 includes a second flow port hydraulically coupled to the fluid reservoir 38. Each of the first pressure relief valve 44 and the second pressure relief valve 46 is normally closed. Each of the first pressure relief valve 44 and the second pressure relief valve 46 may open in response to fluid pressure at the pilot ports thereof exceeding corresponding predetermined pressures (sometimes referred to herein, respectively, as the first and second pressure relief valve set points). As shown, the first pressure relief valve set point is adjustable. The first pump port 26 also is hydraulically coupled to a pilot port of a third pilot-operated check valve 48.

The second pump port 28 is coupled to a first flow port of the third pilot-operated check valve 48 via a retract line 50. A second flow port of the third pilot-operated check valve 48 is connected to the retract chambers 22 of each of the first and second actuators 12A, 12B by a hydraulic line R (retract). The third pilot-operated check valve 48 is normally closed to check flow from the second flow port thereof, to the first flow port thereof. The third pilot-operated check valve 48 enables forward flow, that is, flow from the first flow port thereof to the second flow port thereof, in response to fluid pressure at the first flow port thereof being greater than fluid pressure at the second flow port thereof. The third pilot-operated check valve 48 enables reverse flow, that is, flow from the second flow port thereof to the first flow port thereof, when fluid pressure at a pilot port thereof exceeds a predetermined pressure (sometimes referred to herein as the third pilot-operated check valve set point), thereby opening the valve.

The second pump port 28 also is hydraulically coupled to a second suction line 52 having a free end configured to draw fluid from the hydraulic fluid reservoir 38. A second suction line check valve 54 and a second suction line filter/strainer 56 are disposed in the second suction line 52 between the reservoir 38 and the second port 28 of the pump 24, with the second filter/strainer on the reservoir side of the second check valve.

The second pump port 28 further is hydraulically coupled to a first flow port and a pilot port of a third pressure relief valve 58 (and also, as discussed above, to the pilot port of the second pressure relief valve 46.). A second flow port of the third pressure relief valve 58 is hydraulically coupled to the fluid reservoir 38. The third pressure relief valve 58 is normally closed. The third pressure relief valve 58 may open in response to pressure at the pilot port thereof exceeding a corresponding pressure (sometimes referred to herein as the third pressure relief valve set point).

The second pump port 28 also is hydraulically coupled to the pilot port of the first pilot-operated check valve 34A and the pilot port of the second pilot-operated check valve 34B.

As set forth above, the first and second suction line check valves 40, 54, the first, second and third pressure relief valves 44, 46, 58, and the first, second and third pilot-operated check valves 32A, 32B, and 48 are normally closed. For example, they are closed when the pump 24 is not running and the hydraulic system is in a steady state.

With the first, second and third pilot-operated check valves 32A, 32B, and 48 closed, the hydraulic fluid in the extend and retract chambers 20, 22 of the first and second actuators 12A, 12B has no means of escape therefrom (absent unintended fluid leakage through any of the pilot-operated check valves or fluid lines or seals). As such, the pistons 16 and piston rods 18 of the first and second actuators 12A, 12B are fixed (absent any unintended fluid leakage between the respective pistons and cylinders), and the extend chambers 20 of the first and second actuators 12A, 12B are hydraulically isolated from each other when the first, second and third pilot-operated check valves 32A, 32B, and 48 closed.

The piston rods 18 of the first and second actuators 12A, 12B may be extended by adding fluid to the extend chambers 20 thereof and relieving fluid from the retract chambers 22 thereof. This may be accomplished by operating the bi-directional motor 30 in the first (or extend) direction, thereby driving the bi-directional pump 24 in the first (or extend) direction.

More specifically, when the pump 24 is started in the extend direction, the pump draws hydraulic fluid through the second pump port 28 and pumps it out through the first pump port 26, thereby pressurizing the hydraulic fluid in the extend line 34. Such hydraulic fluid may initially be drawn from the retract line 50 or from the reservoir 38 through the second suction line 52. When the pressure in the extend line 34 exceeds the third pilot-operated check valve set point, the third pilot-operated check valve 48 opens, thereby allowing flow of hydraulic fluid from the retract chambers 22 of the first and second actuators 12A, 12B to the second pump port 28. In this state, with the pump 24 continuing to run in the extend direction, the hydraulic pressure in the extend line 34 exceeds the hydraulic pressure in the retract chambers 22 of the actuators 12A, 12B and the retract line 50. As such, the hydraulic fluid may flow through the flow ports of the first and second pilot-operated check valves 32A, 32B, and into the extend chambers 20 of the first and second actuators 12A, 12B, thereby displacing the pistons 16 and piston rods 18 thereof in an extend direction.

The retract chambers 22 of the actuators 12A, 12B have a smaller free volume per unit of piston displacement than the extend chambers 20 because of the presence of the piston rods 18 in the retract chambers. As such, the volume of fluid relieved from the retract chambers 22 during the foregoing pump operation is less than the volume of fluid required to be added to the extend chambers. The pump 24 may draw any necessary make-up fluid from the reservoir 38 through the second suction line 52.

When the pump 24 is stopped, the fluid pressure in the extend line 34 drops below the third pilot-operated check valve set point, and the third pilot-operated check valve 48 closes, thereby precluding further fluid flow from the retract chambers 22 of the actuators 12A, 12B. Also, the pressure in the extend line 34 drops to or below the pressure in the extend chambers 20 of the first and second actuators 12A, 12B. As such, the first and second pilot-operated check valves 32A, 32B close, thereby precluding fluid flow from the extend chambers 20 of the actuators 12A, 12B. With the first, second, and third pilot-operated check valves 32A, 32B, 48 closed, the pistons 16 and piston rods 18 of the first and second actuators 12A, 12B are fixed and the extend chambers 20 of the first and second actuators 12A, 12B are hydraulically isolated from each other.

When the pump 24 is started in the retract direction, the pump draws hydraulic fluid through the first flow port 26 and pumps it out through the second pump port 28, thereby pressurizing the hydraulic fluid in the retract line 50. When the pressure in the retract line 50 exceeds the first and second pilot-operated check valve set points, the first and second pilot-operated check valves 32A, 32B open, thereby allowing flow of hydraulic fluid from the extend chambers 22 of the first and second actuators 12A, 12B to the first pump port 26. In this state, with the pump 24 continuing to run in the retract direction, the hydraulic pressure in the retract line 50 exceeds the hydraulic pressure in the extend chambers 20 of the actuators 12A, 12B and the extend line 34. As such, the hydraulic fluid may flow through the flow ports of the third pilot-operated check valves 48 and into the retract chambers 22 of the first and second actuators 12A, 12B, thereby displacing the pistons 16 and piston rods 18 thereof in a retract direction.

Because the retract chambers 22 of the actuators 12A, 12B have a smaller free volume per unit of piston displacement than the extend chambers 20, as discussed further above, the volume of fluid relieved from the extend chambers 20 during the foregoing pump operation is greater than the volume of fluid required to be added to the retract chambers. Consequently, the fluid pressure in the retract line 50 will rise above the second pressure relief valve set point, thereby causing the second pressure relief valve 46 to open, in turn allowing excess fluid in the retract line to be relieved to the reservoir 38 through the second pressure relief valve.

When the pump 24 is stopped, the fluid pressure in the retract line 34 drops below the first and second pilot-operated check valve set points, and the second and third pilot-operated check valves 32A, 32B closes, thereby precluding further fluid flow from the extend chambers 20 of the actuators 12A, 12B. Also, the pressure in the retract line 50 drops to or below the pressure in the retract chambers 22 of the first and second actuators 12A, 12B. As such, the third pilot-operated check valve 48 closes, thereby precluding fluid flow from the retract chambers 22 of the actuators 12A, 12B. With the first, second, and third pilot-operated check valves 32A, 32B, 48 closed, the pistons 16 and piston rods 18 of the first and second actuators 12A, 12B are fixed and the extend chambers 20 of the first and second actuators 12A, 1B are hydraulically isolated from each other.

If the pressure in the extend line 34 at any time exceeds the first pressure relief valve set point, the first pressure relief valve 44 opens, thereby relieving fluid to the reservoir 38. Similarly, if the pressure in the retract line 50 at any time exceeds the third pressure relief valve set point, the third pressure relief valve 58 opens, thereby relieving fluid to the reservoir 38.

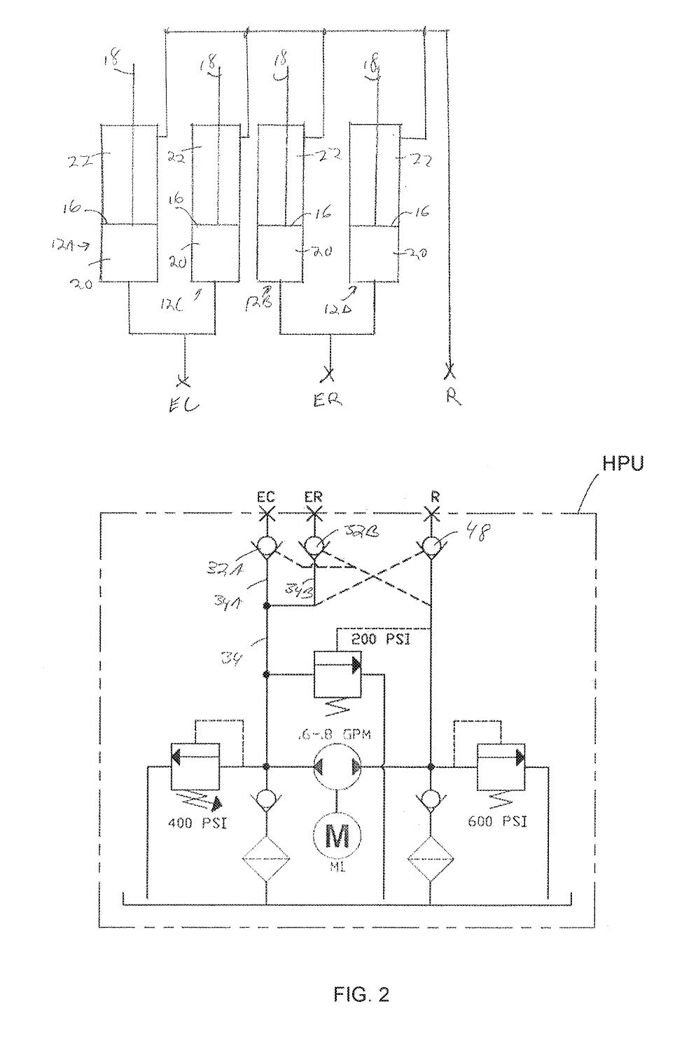

FIG. 2 is a schematic diagram of a hydraulic circuit for a second illustrative embodiment 10 of a hydraulic stabilizing system according to the present disclosure. The second embodiment of FIG. 2 is identical to the first embodiment of FIG. 1 except that the second embodiment of FIG. 2 further includes a third hydraulic actuator 12C hydraulically coupled in series with the first pilot-operated check valve 32A and in parallel with the first hydraulic actuator 12A by the hydraulic line EC, and a fourth hydraulic actuator 12D hydraulically coupled in series with the second pilot-operated check valve 32B and in parallel with the second hydraulic actuator 12B by the hydraulic line ER. The first and third actuators 12A, 12C could be installed, for example, at first (or front) and second (or rear) ends, respectively, of the curb side of the vehicle. The second and fourth actuators 12B, 12D could be installed, for example, at first (or front) and second (or rear) ends, respectively, of the road side of the vehicle.

Operation of the second embodiment is similar to operation of the first embodiment except that operation of the pump 24 in the first direction also causes hydraulic fluid to be added to the extend chambers 20 and removed from the retract chambers 22 of the third and fourth actuators 12C, 12D. Similarly, operation of the pump 24 in the second direction also causes hydraulic fluid to be removed from the extend chambers 20 and removed from the retract chambers 22 of the third and fourth actuators 12C, 12D. Further, hydraulic fluid may be exchanged between the extend chambers 20 of the first and third actuators 12A, 12C through the hydraulic line EC and between the retract chambers 22 of the first and third actuators 12A, 12C through the hydraulic line R with the pump 24 stopped and the first, second, and third pilot-operated check valves 32A, 32B, and 48 closed. Similarly, hydraulic fluid may be exchanged between the extend chambers 20 of the second and fourth actuators 12B, 12D through the hydraulic line ER and between the retract chambers 22 of the second and fourth actuators 12B, 12D through the hydraulic line R with the pump 24 stopped and the first, second, and third pilot-operated check valves 32A, 32B, and 48 closed. As such, the extend chambers of the first and third actuators 12A, 12C are hydraulically isolated from the extend chambers of the second and fourth actuators 12B, 12D, but the extend chambers of the first and third actuators are not hydraulically isolated from each other, and the extend chambers of the second and fourth actuators are not isolated from each other, when the first, second, and third pilot operated check valves 32A, 32B, 48 are closed.

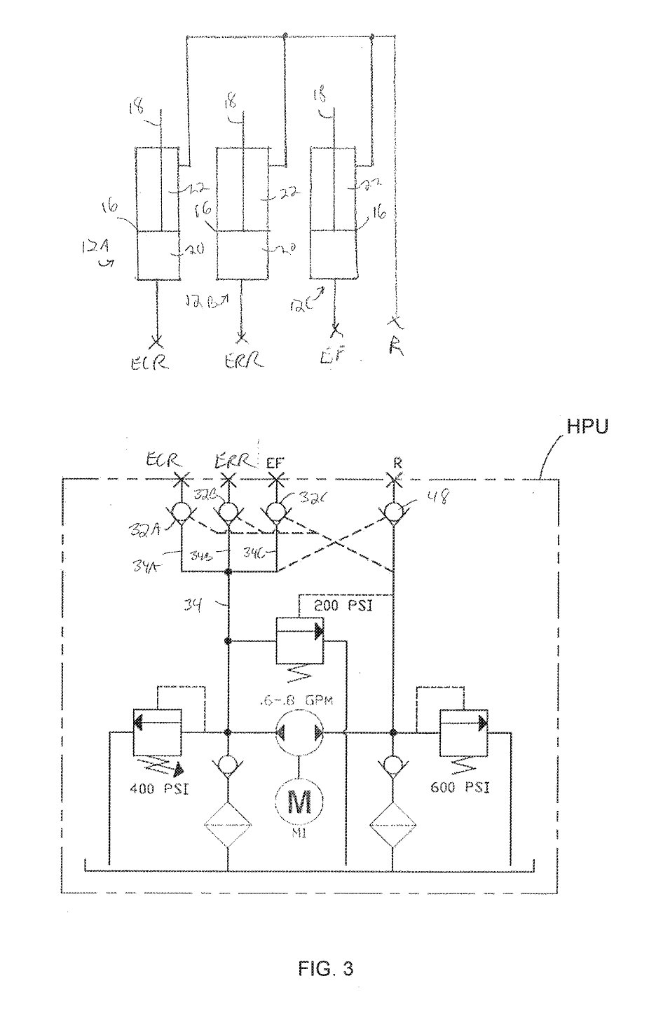

FIG. 3 is a schematic diagram of a hydraulic circuit for a third illustrative embodiment 10 of a hydraulic stabilizing system according to the present disclosure. The third embodiment is similar to the first embodiment, except that the third embodiment includes a third actuator 12C. The first and second actuators 12A, 12B could be installed, respectively, for example, on the curbside and road side of the vehicle proximate the rear end of the vehicle, and the third actuator could be installed, for example, proximate the front end of the vehicle, intermediate the curb side and the road side of the vehicle. Also, the HPU of the third embodiment includes a fourth pilot-operated check valve 32C installed in an extend line 34C and having first and second flow ports hydraulically coupled between the first pump port 26 and an extend chamber 22 of the third actuator 12C, and a pilot port hydraulically coupled to the retract line 50. The fourth pilot-operated check valve 32C operates in a manner similar to the first and second pilot-operated check valves 32A, 32B.

Operation of the third embodiment is similar to operation of the first embodiment, except that operation of the pump in the first direction further causes hydraulic fluid to be added to the extend chamber 20 and removed from the retract chamber 22 of the third actuator 12C, thereby displacing the piston 16 and piston rod 18 of the third actuator in the extend direction. Also, operation of the pump in the second direction further causes hydraulic fluid to be removed from the extend chamber 20 and added to the retract chamber 22 of the third actuator 12C, thereby displacing the piston 16 and piston rod 18 of the third actuator in the retract direction. With the pump 24 stopped and the first, second, third, and fourth pilot operated check valves 32A, 32B, 48, and 32C closed, the pistons 16 and piston rods 18 of the first, second, and third actuators 12A, 12B, 12C are fixed, and the extend chambers 20 of the first, second, and third actuators 12A, 12B are hydraulically isolated from each other.

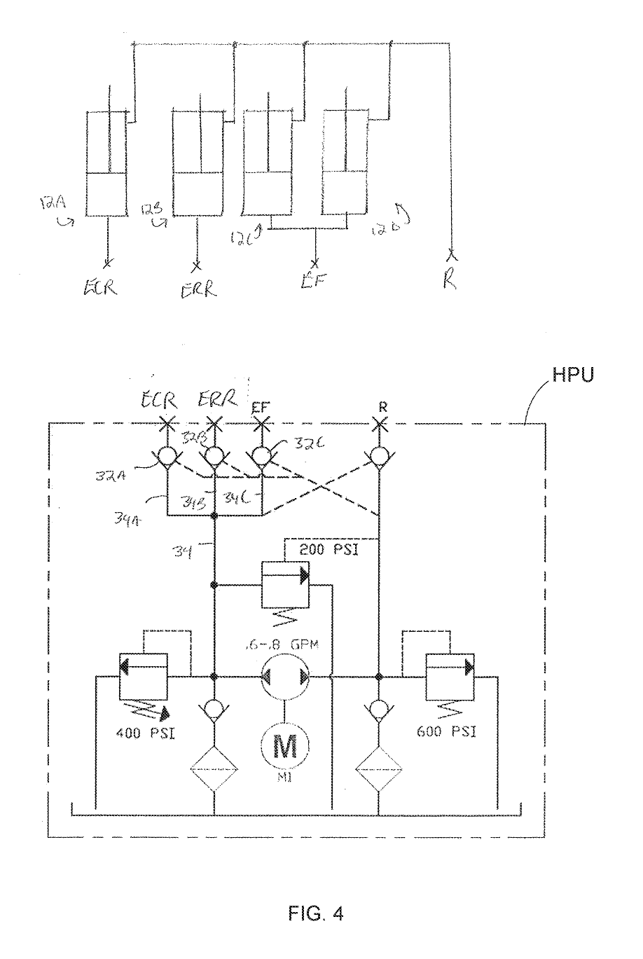

FIG. 4 is a schematic diagram of a hydraulic circuit for a fourth illustrative embodiment 10 of a hydraulic stabilizing system according to the present disclosure. The fourth embodiment is similar to the third embodiment, except that the fourth embodiment includes a fourth actuator 12D hydraulically coupled in series with the third pilot-operated check valve 32C and in parallel with the third actuator 12C. In this embodiment, the third and fourth actuators 12C, 12D could be installed, respectively, at curb and road sides of the vehicle near the front of the vehicle.

Operation of the fourth embodiment is similar to operation of the third embodiment, except that operation of the pump 24 in the first direction also causes hydraulic fluid to be added to the extend chamber 20 and removed from the retract chamber 22 of the fourth actuator 12D. Similarly, operation of the pump 24 in the second direction also causes hydraulic fluid to be removed from the extend chamber 20 and removed from the retract chamber 22 of the fourth actuator 12D. Also, hydraulic fluid may be exchanged between the extend chambers 20 of the second and fourth actuators 12B, 12D and between the retract chambers 22 of the second and fourth actuators 12B, 12D with the pump 24 stopped and the first, second, third, and fourth pilot-operated check valves 32A, 32B, 48, and 32C closed. As such, the extend chambers 20 of the first and second actuators 12A, 12B are hydraulically isolated from each other and from the extend chambers of the third and fourth actuators 12C, 12D, but the extend chambers of the third and fourth actuators are not hydraulically isolated from each other, when the first, second, third, and fourth pilot-operated check valves 32A, 32B, 48, 32C are closed.

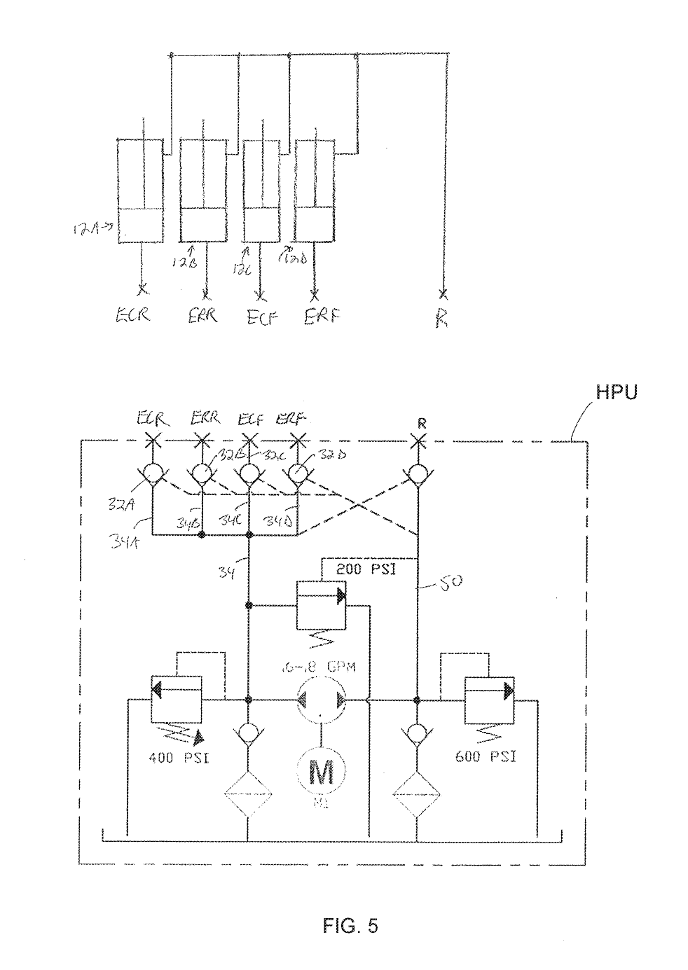

FIG. 5 is a schematic diagram of a hydraulic circuit for a fifth illustrative embodiment 10 of a hydraulic stabilizing system according to the present disclosure. The fifth embodiment is similar to the third embodiment, except that the fifth embodiment includes a fourth actuator 12D hydraulically coupled to a fifth pilot-operated check valve 32D in parallel with the first, second, and fourth pilot-operated check valves 32A, 32B, 32C. In this embodiment, the third and fourth actuators 12C, 12D could be installed, respectively, at curb and road sides of the vehicle near the front of the vehicle.

Operation of the fifth embodiment is similar to operation of the third embodiment, except that operation of the pump 24 in the first direction also causes hydraulic fluid to be added to the extend chamber 20 and removed from the retract chamber 22 of the fourth actuator 12D. Similarly, operation of the pump 24 in the second direction also causes hydraulic fluid to be removed from the extend chamber 20 and added to the retract chamber 22 of the fourth actuator 12D. Also, the pistons 16 and piston rods 18 of the first, second, third, and fourth actuators 12A, 12B, 12C, 12D are fixed and the extend chambers 20 of the first, second, third, and fourth actuators 12A, 12B, 12C, and 12D are hydraulically isolated from each other when the first, second, third, fourth, and fifth pilot-operated check valves 32A, 32B, 48, 32C, 32D are closed.

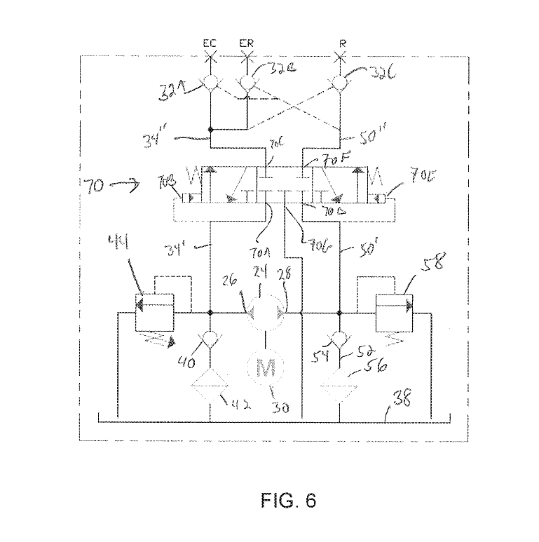

FIG. 6 is a schematic diagram of a hydraulic circuit for a sixth illustrative embodiment 10 of a hydraulic stabilizing system according to the present disclosure. The sixth embodiment is similar to the first embodiment, except that the sixth embodiment omits the second pilot operated relief valve 46 and the reservoir return line at the outlet thereof of the first embodiment and includes instead a pilot-operated directional control valve 70 having an extend circuit hydraulically disposed between first and second portions 34′, 34″ of the extend line 34, a retract circuit hydraulically disposed between first and second portions 50′, 50″of the retract line 50, and a discharge circuit that may be selectively coupled between the second portion 34″of the extend line and the reservoir 38 or between the second portion 50″of the retract line and the reservoir 38.

More specifically, the first portion 34′ of the extend line 34 is hydraulically coupled to the first pump port 26 and to an extend circuit inlet port 70A and an extend-side pilot port 70B of the pilot-operated directional control valve 70. The second portion 34″ of the extend line 34 is hydraulically coupled to an extend circuit outlet port 70C of the pilot-operated directional control valve 70 and to the first flow ports of the first and second pilot-operated check valves 32A, 32B. The first portion 50′ of the retract line 50 is hydraulically coupled to the second pump port 28 and a retract circuit inlet port 70D and a retract-side pilot port 70E of the pilot-operated directional control valve 70. The second portion 50″ of the retract line 50 is hydraulically coupled to a retract circuit outlet port 70F of the pilot-operated directional control valve 70 and to the first flow port of the third pilot-operated check valve 32C. A discharge-to-reservoir port 70G of the pilot-operated directional control valve 70 is hydraulically coupled to the reservoir 38.

In use, operation of the pump 24 in the first direction pressurizes the hydraulic fluid in the first portion 34′ of the extend line and, therefore, at the extend-side pilot port 70B of the pilot-operated directional control valve 70. In response, a movable spool within the pilot-operated directional control valve 70 places the extend circuit inlet port 70A in fluid communication with the extend circuit outlet port 70B and places the retract circuit outlet port 70F in fluid communication with the discharge-to-reservoir port 70G. So configured, the pilot-operated directional control valve 70 enables flow of hydraulic fluid through the extend line 34 and into the extend chambers of the first and second actuators 12A, 12B, as discussed above in connection with the first embodiment. It also enables flow of hydraulic fluid from the retract chambers of the first and second actuators 12A, 12B through the second portion 50″ of the retract line and the return-to-reservoir line to the reservoir 38.

Operation of the pump 24 in the second direction pressurizes the hydraulic fluid in the first portion 50′ of the retract line and, therefore, at the retract-side pilot port 70E of the pilot-operated directional control valve 70. In response, the movable spool within the pilot-operated directional control valve 70 places the retract circuit inlet port 70D in fluid communication with the retract circuit outlet port 70F and places the extend circuit outlet port 70C in fluid communication with the discharge-to-reservoir port 70G. So configured, the pilot-operated directional control valve 70 enables flow of hydraulic fluid through the retract line 50 and into the retract chambers of the first and second actuators 12A, 12B, as discussed above in connection with the first embodiment. It also enables flow of hydraulic fluid from the extend chambers of the first and second actuators 12A, 12B through the second portion 34″ of the extend line and the return-to-reservoir line to the reservoir 38.

In each of the first through sixth embodiments discussed above, the corresponding HPU is disclosed as including a bi-directional motor 30 and bi-directional pump 24 that effect extension and retraction of the piston rods 18 from the respective cylinders 14 of the actuators 12A-12n by operation of the motor and pump in first and second directions, respectively. An alternative HPU could instead include a unidirectional motor and pump and a control valve having first and second output ports hydraulically coupled to the extend and retract lines 34, 50 of the foregoing embodiments.

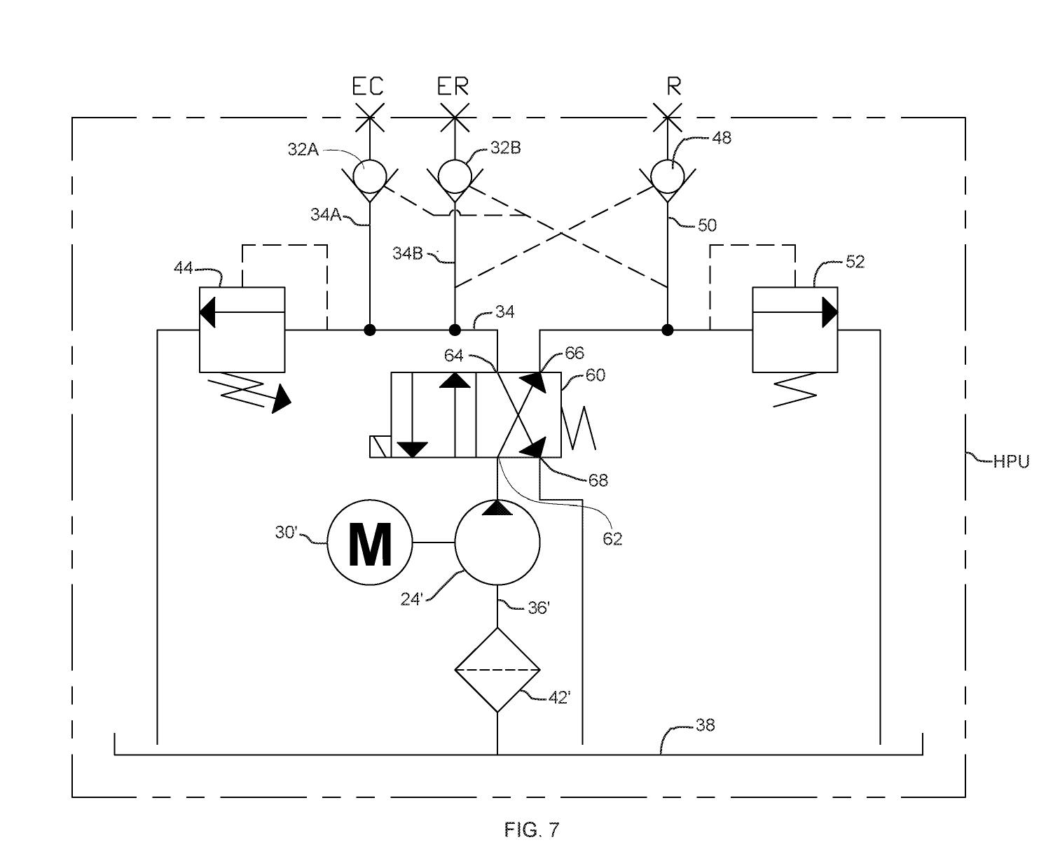

FIG. 7 shows such an alternative HPU incorporated into the first embodiment of FIG. 1. More specifically, FIG. 6 shows an HPU including a unidirectional pump 24′ and a unidirectional motor 30′ connected to and configured to selectively drive the pump 24′. The suction side of the pump 24′ is hydraulically coupled to a suction line 36′ configured to draw hydraulic fluid from the reservoir 38 through an intervening strainer 42′. The discharge side of the pump 24′ is hydraulically coupled to a pump port 62 of a control valve 60. The extend line 34 is hydraulically coupled to an extend port 64 of the control valve 60. The retract line 50 is hydraulically coupled to a retract port 66 of the control valve 60. A reservoir port 68 of the control valve 60 is hydraulically coupled to the reservoir. The control valve 60 is selectively reconfigurable between a first (or extend) configuration in which the pump port 62 is aligned and in fluid communication with the extend port 64 and the retract port 66 is aligned and in fluid communication with the reservoir port 68, and a second (or retract) configuration in which the pump port 62 is aligned and in fluid communication with the retract port 66 and the extend port 64 is aligned and in fluid communication with the reservoir port 68. The control valve 60 may be a spool valve having a spool operable to selectively place the control valve into either of the foregoing first and second configurations.

In operation, with the pump 24′ running, the control valve 60 may be operated to selectively direct pressurized hydraulic fluid to the extend line 34 through the extend port 64 or to the retract line 50 through the retract port 66. With the control valve 60 in the first configuration, the control valve directs pressurized hydraulic fluid to the extend line 34, and it allows hydraulic fluid to be relieved from the retract line 50 to the reservoir 38, thereby allowing the system 10 to operate in a manner similar to that described in connection with the FIG. 1 embodiment with the bi-directional pump 24 thereof running in the first direction. With the control valve 60 in the second configuration (as shown in FIG. 6), the control valve directs pressurized hydraulic fluid to the retract line 50, and it allows hydraulic fluid to be relieved from the extend line 34 to the reservoir, thereby allowing the system 10 to operate in a manner similar to that described in connection with the FIG. 1 embodiment with the bi-directional pump 24 thereof running in the second direction.

FIG. 7 shows a further alternative

The HPU's of the second through fifth embodiments of FIGS. 2-5 could be similarly modified and operated in a similar manner

Set points and flow rates shown in the drawings are illustrative and not limiting. Such set points and flow rates could be selected as desired.

Features shown and described in connection with a given embodiment may incorporated into any other embodiment to the greatest extent possible.

1. A hydraulic stabilizing system comprising:
a bi-directional hydraulic pump having a first pump flow port and a second pump flow port;
a first hydraulic actuator comprising a cylinder and a piston slidably received within the cylinder, the piston and the cylinder cooperating to define an extend chamber and a retract chamber;
a second hydraulic actuator comprising a cylinder and a piston slidably received within the cylinder, the piston and the cylinder cooperating to define an extend chamber and a retract chamber;
a first pilot-operated check valve having a first flow port in fluid communication with the first pump flow port, and a second flow port in fluid communication with the extend chamber of the first actuator so as to selectively check flow of fluid from the extend chamber of the first actuator;
a second pilot-operated check valve having a first flow port in fluid communication with the first pump flow port, and a second flow port in fluid communication with the extend chamber of the second actuator so as to selectively check flow from the extend chamber of the second actuator; and
a third pilot-operated check valve having a first flow port in fluid communication with the second pump flow port, and a second flow port in communication with the retract chambers of the first and second actuators so as to check flow from the retract chambers of the first and second actuators;
the first pilot-operated check valve further having a pilot port in fluid communication with the second pump flow port;
the second pilot-operated check valve further having a pilot port in fluid communication with the second pump flow port; and
the third pilot-operated check valve further having a pilot port in fluid communication with the first pump flow port.

2. The hydraulic stabilizing system of claim 1 further comprising:
a third hydraulic actuator comprising a cylinder and a piston slidably received within the cylinder, the piston and the cylinder cooperating to define an extend chamber and a retract chamber; and
a fourth hydraulic actuator comprising a cylinder and a piston slidably received within the cylinder, the piston and the cylinder cooperating to define an extend chamber and a retract chamber;
the second flow port of the first pilot-operated check valve further in fluid communication with the extend chamber of the third actuator; and
the second flow port of the second pilot-operated check valve further in fluid communication with the extend chamber of the fourth actuator.

3. The hydraulic stabilizing system of claim 1 further comprising:
a third hydraulic actuator comprising a cylinder and a piston slidably received within the cylinder, the piston and the cylinder cooperating to define an extend chamber and a retract chamber; and
a fourth pilot-operated check valve having a first flow port in fluid communication with the first pump flow port, and a second flow port in fluid communication with the extend chamber of the third actuator so as to selectively check flow from the extend chamber of the fourth actuator;
the fourth pilot-operated check further valve having a pilot port in fluid communication with the second pump flow port.

4. The hydraulic stabilizing system of claim 3 further comprising:
a fourth hydraulic actuator comprising a cylinder and a piston slidably received within the cylinder, the piston and the cylinder cooperating to define an extend chamber and a retract chamber;
the second flow port of the fourth pilot-operated check valve further in fluid communication with the extend chamber of the fourth actuator.

5. The hydraulic stabilizing system of claim 1 further comprising:
a third hydraulic actuator comprising a cylinder and a piston slidably received within the cylinder, the piston and the cylinder cooperating to define an extend chamber and a retract chamber; and
a fourth hydraulic actuator comprising a cylinder and a piston slidably received within the cylinder, the piston and the cylinder cooperating to define an extend chamber and a retract chamber;
a fourth pilot-operated check valve having a first flow port in fluid communication with the first pump flow port, and a second flow port in fluid communication with the extend chamber of the third actuator so as to selectively check flow from the extend chamber of the third actuator; and
a fifth pilot-operated check valve having a first flow port in fluid communication with the first pump flow port, and a second flow port in fluid communication with the extend chamber of the fourth actuator so as to selectively check flow from the extend chamber of the fourth actuator;
the fourth pilot-operated check further valve having a pilot port in fluid communication with the second pump flow port; and
the fifth pilot-operated check further valve having a pilot port in fluid communication with the second pump flow port.

6. The hydraulic stabilizing system of claim 1 further comprising:
a fluid reservoir; and
a first pressure relief valve having a first flow port in fluid communication with the first pump flow port, and a second flow port in fluid communication with the fluid reservoir.

7. The hydraulic stabilizing system of claim 6, the first pressure relief valve further having a pilot port in fluid communication with the first pump flow port.

8. The hydraulic stabilizing system of claim 6, the first pressure relief valve further having a pilot port in fluid communication with the second pump flow port.

9. The hydraulic stabilizing system of claim 6 further comprising a second pressure relief valve having a first flow port in fluid communication with the first pump flow port, and a second flow port in fluid communication with the fluid reservoir.

10. The hydraulic stabilizing system of claim 9, the second pressure relief valve further having a pilot port in fluid communication with the second pump flow port.

11. The hydraulic stabilizing system of claim 10, the first pressure relief valve further having a pilot port in fluid communication with the first pump flow port.

12. The hydraulic stabilizing system of claim 9 further comprising a third pressure relief valve having a first flow port in fluid communication with the second pump flow port, and a second flow port in fluid communication with the fluid reservoir.

13. The hydraulic stabilizing system of claim 6 further comprising a second pressure relief valve having a first flow port in fluid communication with the second pump flow port, and a second flow port in fluid communication with the fluid reservoir.

14. The hydraulic stabilizing system of claim 1 further comprising a first fluid supply line check valve having a first flow port in fluid communication with the reservoir and a second flow port in fluid communication with one of the first pump flow port and the second pump flow port, the first fluid supply line check valve configured to check flow from the second flow port thereof to the first flow port thereof.

15. The hydraulic stabilizing system of claim 14 further comprising a second fluid supply line check valve having a first flow port in fluid communication with the reservoir and a second flow port in fluid communication with the other of the first pump flow port and the second pump flow port, the second fluid supply line check valve configured to check flow from the second flow port thereof to the first flow port thereof.

16. A hydraulic stabilizing system comprising:
a hydraulic pump having an inlet port and an outlet port;
a hydraulic control valve having a pump port, an extend port, a retract port, and a fluid discharge port;
a first hydraulic actuator comprising a cylinder and a piston slidably received within the cylinder, the piston and the cylinder cooperating to define an extend chamber and a retract chamber;
a second hydraulic actuator comprising a cylinder and a piston slidably received within the cylinder, the piston and the cylinder cooperating to define an extend chamber and a retract chamber;
a first pilot-operated check valve having a first flow port in fluid communication with the extend port, and a second flow port in fluid communication with the extend chamber of the first actuator so as to selectively check flow of fluid from the extend chamber of the first actuator;
a second pilot-operated check valve having a first flow port in fluid communication with the extend port, and a second flow port in fluid communication with the extend chamber of the second actuator so as to selectively check flow from the extend chamber of the second actuator; and
a third pilot-operated check valve having a first flow port in fluid communication with the retract port, and a second flow port in communication with the retract chambers of the first and second actuators so as to check flow from the retract chambers of the first and second actuators;
the first pilot-operated check valve further having a pilot port in fluid communication with the retract port;
the second pilot-operated check valve further having a pilot port in fluid communication with the retract port; and
the third pilot-operated check valve further having a pilot port in fluid communication with the extend port.

17. The hydraulic stabilizing system of claim 16 wherein the control valve is a spool valve.
